(19) United States
(12) Patent Application Publication
(10) Pub. No.: US 2011/0174581 A1
(43) Pub. Date: Jul. 21, 2011

(54) BRAKE CALIPER FOR A DISK BRAKE

(76) Inventors: Herbert Vollert, Vaihingen/Eng (DE); Anton Dukart, Gerlingen (DE); Bertram Foitzik, Ilsfeld (DE); Willi Nagel, Hochdorf (DE); Bernd Goetzelmann, Rutesheim (DE)

(21) Appl. No.: 13/120,611

(22) PCT Filed: Sep. 14, 2009
(86) PCT No.: PCT/EP09/61877

§ 371 Date: Mar. 23, 2011

(30) Foreign Application Priority Data
Sep. 23, 2008 (DE) 10-2008-042-298.3

(51) Int. Cl. F16D 55/22; G01L 5/28

(52) U.S. Cl. 188/72.1; 188/71.1; 73/121

(57) ABSTRACT

The invention relates to a brake caliper of an electromechanical disk brake. According to the invention, in order to measure a widening of a brake caliper when the brake is activated, a rod-shaped holder which is clamped on one side, is arranged in a cavity in a yoke of the brake caliper, perpendicular to a brake disk and a movement of the free end of the holder is measured, for example by means of a magnetic sensor. The widening of the brake caliper is a measurement for the clamping force when the brake disk is actuated.

### PRIOR ART

The invention relates to a brake caliper for a disc brake, having a device for measuring a deformation of the brake caliper by an application force during actuation of the disc brake, with the defining characteristics of the preamble to claim 1. The application force is the force with which brake pads are pressed against a brake disc during actuation of the disc brake. The application force deforms the brake caliper elastically, splaying it open. The deformation of the brake caliper is therefore a measure of the application force. The purpose of measuring the deformation of the brake caliper is usually to regulate the braking force of the disc brake or to regulate the application force on which the braking force depends via the coefficient of friction μ.

Various possibilities have been proposed for measuring the deformation of a brake caliper in order to regulate the application force or braking force. For example, the patent application DE 103 28 242 A1 has disclosed mounting a strain gauge in the vicinity of the yoke of a brake caliper in order to measure the deformation of the brake caliper. The yoke is the region of the brake caliper that spans the circumference region of the brake disc.

In addition to a strain gauge, the patent application DE 102 01 555 A1 has proposed placing a piezoelectric element between a brake pad and the brake caliper and using it to measure the pressing force of the brake pad against the brake disc and therefore the application force of the disc brake itself.

In lieu of this, the patent application DE 103 14 449 A1 has proposed placing a magnetic sensor between a brake pad and the brake caliper and using it to measure the changes that the application force induces in a magnetic field of a permanent magnet, for example. The cited patent application proposes using magnetic sensors in the form of AMR sensors or GMR sensors, which are intrinsically known.

The patent application DE 101 52 422 A1 has proposed placing a force sensor in the form of a transducer between a brake pad and an electromechanical actuator and using it to measure the application force of the disc brake. The electromechanical actuator has an electric motor and for example a screw link actuator that converts the rotary motion of the electric motor into a linear motion with which it presses the brake pad against the brake disc in order to actuate the disc brake.

### DISCLOSURE OF THE INVENTION

The brake caliper according to the invention, with the defining characteristics of claim 1 has a holder that is attached in stationary fashion to the brake caliper at an attachment point. The measurement of the deformation of the brake caliper preferably occurs at the free end of the holder and in any case, spaced apart from the attachment point of the holder. The deformation of the brake caliper during an actuation of the disc brake causes the brake caliper to move in relation to the holder; the movement between the holder and brake caliper is therefore a measure of the deformation of the brake caliper and thus of the application force with which the brake pad is pressed against the brake disc during the actuation of the disc brake. For example, the holder can be embodied in the form of a rod and fastened at one end to the brake caliper. Since a holder that is fastened at only one end is not subjected to strain, it is therefore not deformed along with the brake caliper so that the deformation of the brake caliper causes a movement of the holder relative to the brake caliper, which can be measured at the free end of the holder. However, the holder can also be embodied in the form of a bending beam that is connected at both ends to the brake caliper so that it is deformed along with a deformation of the brake caliper. In this case as well, a movement of the holder relative to the brake caliper during a deformation of the brake caliper and holder can be measured, for example, in the middle between the fastening points. It is also possible, for example, to use a strain gauge to measure the deformation of the holder. The holder can also be embodied as flat and fastened all around the brake caliper or can be embodied in another way that causes it to also be deformed along with the deformation of the brake caliper, thus permitting measurement of a relative movement between the holder and the brake caliper or the deformation of the holder. The distance of the measuring location from the attachment point of the holder to the brake caliper makes it possible to achieve a comparatively large movement between the holder and brake caliper when a deformation of the brake caliper occurs, thus achieving high measurement precision. The measurement is executed without force; in particular, the measuring device is not subjected to the application force of the disc brake. Preferably, the holder should be embodied, positioned, and fastened to permit the greatest possible movement relative to the braking caliper during the deformation of the latter by an application force. In particular, the holder is positioned in the region of the yoke of the brake caliper, transversely spanning the brake disc.

In one embodiment of the invention, the holder is positioned in a cavity in the brake caliper. The device for measuring the deformation is integrated into the brake caliper and is thus protected from external influences, particularly from water and dirt. The holder, embodied in the form of a rod that is fastened at one end or in the form of a bending beam that is fastened at both ends, can be situated in a hole, for example in the yoke of the brake caliper. The hole or in general the cavity is manufactured during the casting of the brake caliper and in this case, does not require a separate machining step.

In one embodiment of the invention, the holder has a temperature expansion coefficient that is the same or at least similar to that of the brake caliper in order to minimize an influence of temperature changes on the measurement.

In particular, the invention is provided for an electromechanical disc brake, i.e. for a disc brake that has an electrochemical actuator.

### BRIEF DESCRIPTION OF THE DRAWINGS

The invention will be described in greater detail below in conjunction with two exemplary embodiments shown in the drawings.

FIG. 1 shows a cross-section through a first embodiment of a brake caliper according to the invention;

FIG. 2 shows the brake caliper from FIG. 1 when the disc brake is actuated;

FIG. 3 shows a cross-section through a second embodiment of a brake caliper according to the invention; and

FIG. 4 shows the brake caliper from FIG. 3 when the disc brake is actuated.

The figures are simplified schematic depictions provided for comprehension and explanation of the invention.

### EXEMPLARY EMBODIMENTS OF THE INVENTION

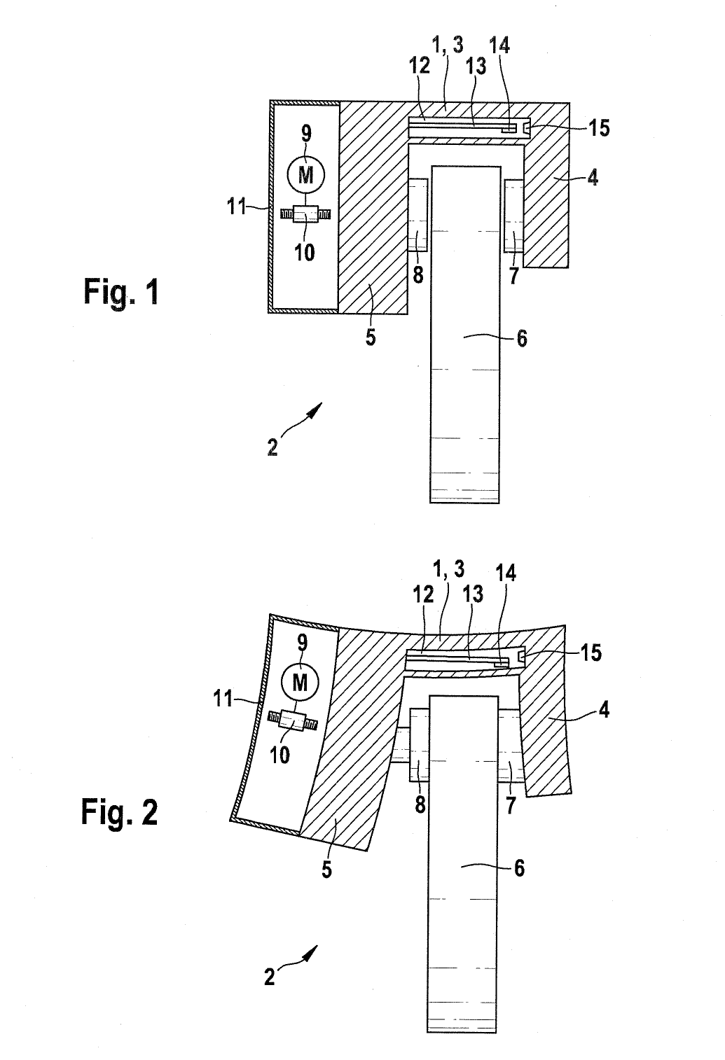

FIG. 1 shows cross-section through a brake caliper 1 of a disc brake 2 according to the invention. The brake caliper 1 has a yoke 3 and two arms 4, 5 on either side of a brake disc 6. The yoke 3 is the region that spans the brake disc 6 outside its circumference and connects the two arms 4, 5 to each other. A brake pad 7 is affixed to the inside of the one arm 4. The inside is the side of the arm 4 oriented toward the brake disc 6. A brake pad 8 is mounted to the inside of the other arm 5 and can be pressed against the brake disc 6 when the disc brake 2 is actuated. As a result, it shifts the brake caliper 1 transversely to the brake disc 6 so that the other brake pad 7 is also pressed against the other side of the brake disc 6, braking the latter. In order to press the brake pad 8 against the brake disc 6, the brake caliper 1 has an actuator with an electric motor 9 and a transmission, e.g. a screw link actuator 10, which converts a rotary drive motion of the electric motor 9 into a linear motion with which the brake pad 8 can be pressed against the brake disc 6. The disc brake 2 is consequently a so-called electromechanical disc brake 2. The actuator 9, 10 is situated in a housing 11 on one side of the brake caliper 1.

In the yoke 3, the brake caliper 1 has a cavity 12 that is embodied in the form of an oblong hole and extends transversely from one side to the other, i.e. from one arm 5 of the brake caliper 1 to the other arm 4. The term “oblong” means that the hole has a length or depth that constitutes a multiple of its transverse dimension. The cavity 12 constituting the hole is formed during the casting of the brake caliper 2, for example by means of a core positioned in the casting mold so that manufacturing the cavity 12 does not require a separate work step. Inside the cavity 12, a rod-shaped holder 13 is provided, whose one end is attached in stationary fashion to the brake caliper 1. The other end of the holder 13 extends freely and supports a magnetic sensor 14 that cooperates with a permanent magnet 15 mounted in the cavity 12 close to the magnetic sensor 14. The magnetic sensor 14 is a sensor chip, i.e. an electronic component, that is equipped for example with a Hall sensor, an AMR sensor, or a GMR sensor. The magnetic sensor 14 reacts to changes in the magnetic field of the permanent magnet 15, i.e. for example to a position change of the magnetic sensor 14 relative to the permanent magnet 15. Such magnetic sensors 14 are known to the person of average skill in the art and therefore require no further explanation here. The rod-shaped holder 13 is composed of the material that has virtually the same temperature expansion coefficient as the brake caliper 1 so that temperature changes have virtually no influence on the position of the magnetic sensor 14 relative to the permanent magnet 15. It is also possible for the magnetic sensor 14 to be fixed in position in the cavity 12 of the brake caliper 1 and for the permanent magnet 15 to be positioned on the free end of the holder 13. Another possibility is for the magnetic sensor 14 and the permanent magnet 15 to be fixed in position in the cavity 12 of the brake caliper 1, with the holder 13 situated between them. The holder 13 influences a magnetic field of the permanent magnet 15 and a movement of the holder 13 relative to the permanent magnet 15 produces a change in the latter's magnetic field, which can be measured with the magnetic sensor 14. The embodiment options above do not constitute an exhaustive list of the possible embodiments.

In order to actuate the disc brake 1, the electrochemical actuator 9, 10 presses the one brake pad 8 against the one side of the brake disc 6. As mentioned above, the brake caliper 1 is shifted transversely to the brake disc 6 and presses the other brake pad 7 against the other side of the brake disc 6. An application force exerted by the actuator 9, presses the brake pads 7, 8 against the brake disc 6 from both sides. Because the arms 4, 5 of the brake caliper 1 are pushed away from each other, the brake caliper 1 is splayed open elastically, as depicted in exaggerated fashion in FIG. 2. The splaying of the brake caliper 1 causes its yoke 3 and the cavity 12 to bend. The rod-shaped holder 13, whose one end is attached in stationary fashion to the brake caliper 1 and whose other and extends freely, is not deformed by the deformation of the brake caliper 1; consequently, its free end moves relative to the permanent magnet 15, which is affixed in the cavity 12 of the brake caliper 1. This movement of the free end of the holder 13 relative to the permanent magnet 15 due to the splaying of the brake caliper 1 during actuation of the disc brake 2 can be measured with the magnetic sensor 14 that is mounted on the free end of the holder 13. The magnetic sensor 14 can therefore be used to measure the splaying of the brake caliper 1, which is a measure for the application force with which the brake pads 7, 8 are pressed against the brake disc 6. It is thus possible to regulate a braking force or at any rate the application force of the disc brake 2. The permanent magnet 15 and the holder 13 with the magnetic sensor 14 thus constitute a device for measuring the deformation of the brake caliper 1 by the application force with which the brake pads 7, 8 are pressed against the brake disc 6 during an actuation of the disc brake 2. The splaying or in general deformation of the brake caliper 2 does not have to be measured magnetically; it is also possible to use other measuring methods such as inductive, capacitive, or optical measurement of the position change of the free end of the holder 13 in the cavity 12 of the brake caliper 1.

The placement of the measuring device in the cavity 12 protects the measuring device from external influences such as water and dirt. The holder 13, the magnetic sensor 14, and the permanent magnet 15 are preferably embodied and positioned so that a given splaying of the brake caliper 1 results in a large movement of the magnetic sensor 14 relative to the permanent magnets 15, i.e. a large measurement signal. In the embodiment shown, a placement in the yoke 3 of the brake caliper 1 in a transverse direction relative to the brake disc 6 has been selected. A placement, for example, in one of the arms 4, 5 of the brake caliper 1 in a radial direction relative to the brake disc 6 (not shown) is also conceivable. It is additionally conceivable to provide an L-shaped holder that extends through the yoke 3 and one of the two arms 4, 5 of the brake caliper 1 and increases the movement of the magnetic sensor 14 relative to the permanent magnet 15 in comparison to the embodiment shown. A straight holder 13 in a straight cavity 12, however, is easier to manufacture and assemble and has therefore been selected here. It is also conceivable to provide a U-shaped holder that extends through one arm 5 of the brake caliper 1, through the yoke 3, and through the other arm 4 (not shown). Such a U-shaped holder does in fact result in a greater movement of its free end relative to the brake caliper 1, i.e. the largest possible measurement signal, but also results in a high cost for manufacture and assembly.

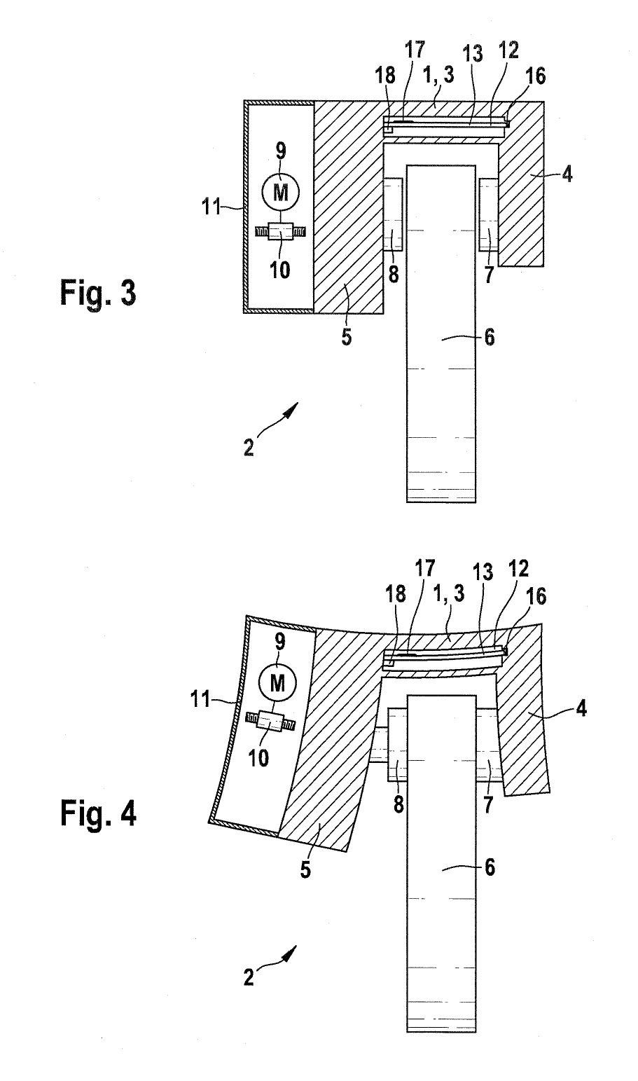

The brake caliper 1 from FIG. 3 is embodied essentially the same as the brake caliper 1 from FIG. 1; it also has an oblong cavity 12 in its yoke 3 in which a holder 13 and a device for measuring the deformation or splaying of the brake caliper 1 by the application force during an actuation of the disc brake 2 [sic]. Descriptions of shared features can therefore be found in the descriptions of FIGS. 1 and 2 and the explanation below will be essentially limited exclusively to the differences. Components that remain the same have been provided with the same reference numerals.

In FIG. 3, the holder 13 is strip-shaped and its one end is attached in stationary fashion to the brake caliper 1. The other end of the holder 13 rests on a support 16 in the cavity 12 of the brake caliper 1. When the brake caliper 1 is splayed open by the application force with which the brake pads 7, 8 are pressed against the brake disc 6 during an actuation of the disc brake 2, this elastically bends the holder 13. The splaying of the brake caliper 1 and the bending of the holder 13 are depicted in exaggerated fashion in FIG. 4. The holder 13 has a strain gauge 17 with which the bending of the holder of 13 can be measured. The bending of the holder 13 is a measure for the splaying of the brake caliper 1 and thus for the application force of the disc brake 2. The strain gauge 17 can, for example, be glued to the holder 13. It is also possible to manufacture the holder 13 from an electrically nonconductive material or to provide its surface with an electrically nonconductive coating, at least in the region of the strain gauge 17 and to mount the strain gauge 17 or more precisely stated, its meander-shaped conductor tracks, directly to the holder 13. A sensor chip 18 is positioned in the immediate vicinity of the strain gauge 17 in the cavity 12 in the brake caliper 1. The sensor chip 18 is equipped with evaluation electronics for the strain gauge 17.

The invention is not limited to the depicted brake caliper design of a sliding caliper; it can also be implemented in other caliper designs. One other example is a so-called frame caliper (not shown), which instead of arms 4, 5, has plates on the two sides of the brake disc, which plates are connected at their ends by armatures that extend transversely relative to the brake disc, outside its circumference. Since the armatures of a frame caliper are essentially only subjected to tensile force, it should be possible for the holder 13 of the device for measuring the deformation of the brake caliper to be positioned in one of the caliper's plates, in the region between an armature and a longitudinal center of the plate, parallel to an imaginary chord of the brake disc.

1-7. (canceled)

8. A brake caliper for a disc brake, having
a device for measuring a deformation of the brake caliper by an application force during actuation of the disc brake,
the device having a holder that is attached in a stationary fashion to the brake caliper at an attachment point, wherein
the device measures a movement of the holder relative to the brake caliper spaced apart from the attachment point of the holder to the brake caliper.

9. The brake caliper according to claim 8, wherein the holder is situated in a cavity of the brake caliper.

10. The brake caliper according to claim 8, wherein the holder is situated in the region of a yoke of the brake caliper.

11. The brake caliper according to claim 8, wherein the holder is attached to the brake caliper in such a way that it is deformed along with a deformation of the brake caliper by an application force upon actuation of the disc brake and the deformation of the holder is measured.

12. The brake caliper according to claim 9, wherein the holder is attached to the brake caliper in such a way that it is deformed along with a deformation of the brake caliper by an application force upon actuation of the disc brake and the deformation of the holder is measured.

13. The brake caliper according to claim 10, wherein the holder is attached to the brake caliper in such a way that it is deformed along with a deformation of the brake caliper by an application force upon actuation of the disc brake and the deformation of the holder is measured.

14. The brake caliper according to claim 8, wherein the holder has the same temperature expansion coefficient as the brake caliper.

15. The brake caliper according to claim 9, wherein the holder has the same temperature expansion coefficient as the brake caliper.

16. The brake caliper according to claim 10, wherein the holder has the same temperature expansion coefficient as the brake caliper.

17. The brake caliper according to claim 11, wherein the holder has the same temperature expansion coefficient as the brake caliper.

18. The brake caliper according to claim 12, wherein the holder has the same temperature expansion coefficient as the brake caliper.

19. The brake caliper according to claim 13, wherein the holder has the same temperature expansion coefficient as the brake caliper.

20. The brake caliper according to claim 8, wherein the device for measuring the deformation of the brake caliper has a magnetic sensor or a strain gauge.

21. The brake caliper according to claim 9, wherein the device for measuring the deformation of the brake caliper has a magnetic sensor or a strain gauge.

22. The brake caliper according to claim 10, wherein the device for measuring the deformation of the brake caliper has a magnetic sensor or a strain gauge.

23. The brake caliper according to claim 11, wherein the device for measuring the deformation of the brake caliper has a magnetic sensor or a strain gauge.

24. The brake caliper according to claim 14, wherein the device for measuring the deformation of the brake caliper has a magnetic sensor or a strain gauge.

25. The brake caliper according to claim 8, wherein the brake caliper has an electromechanical actuator for actuating the disc brake.

26. The brake caliper according to claim 9, wherein the brake caliper has an electromechanical actuator for actuating the disc brake.

27. The brake caliper according to claim 10, wherein the brake caliper has an electromechanical actuator for actuating the disc brake.
